(19) United States
(12) Patent Application Publication
(10) Pub. No.: US 2026/0089764 A1
(43) Pub. Date: Mar. 26, 2026

(54) SECURED PHYSICAL RANDOM ACCESS CHANNEL RESOURCES FOR TRUSTED USER EQUIPMENT

(71) Applicant: Nokia Technologies Oy, Espoo (FI)

(72) Inventors: Juha Sakari KORHONEN, Espoo (FI); Luis Guilherme UZEDA GARCIA, Massy (FR); Zexian LI, Espoo (FI); Frank FREDERIKSEN, Klarup (DK)

(21) Appl. No.: 19/110,488

(22) PCT Filed: Aug. 25, 2023
(86) PCT No.: PCT/EP2023/073357

§ 371 Date: Mar. 11, 2025

(30) Foreign Application Priority Data
Sep. 14, 2022 (FI) 20225798

(51) Int. Cl. H04W 74/0833; H04L 9/08

(52) U.S. Cl. CPC H04W 74/0833; H04L 9/0822

(57) ABSTRACT

The present disclosure relates to a technique for configuring secured (or hidden) Physical Random Access Channel (PRACH) resources for trusted User Equipments (UEs) in a wireless communication network. According to the technique, a set of secured PRACH resources each having an ID is signaled by a network node to a trusted UE (preferably by using an encrypted message). When it is detected that a set of public PRACH resources currently used by the trusted UE for PRACH preamble transmissions is under a malicious attack (e.g., a jamming attack), the network node selects, among the set of secured PRACH resources, one or more secured PRACH resources which may be used instead of the public PRACH resources for the PRACH preamble transmissions. The ID(s) of the selected secured PRACH resource(s) is(are) signaled by the network node to the UE. The PRACH resources thus configured are better protected from malicious attacks.

### TECHNICAL FIELD

The present disclosure relates generally to the field of wireless communications, and particularly to a technique for using hidden (or, in other words, secured) Physical Random Access Channel (PRACH) resources for trusted User Equipments (UEs) in a wireless communication network.

### BACKGROUND

Considering the potential applications of the upcoming Sixth Generation (6G) communication technology, one can see that it will be adapted to support even more applications (including features and optimizations) compared to the Fifth Generation (5G) communication technology. One of the growing areas is a campus network (e.g., for industrial usage), which most likely includes critical communications. Critical industries have no tolerance to the disruption of their production lines or operations due to the unavailability or unreliability of their communication channels. This has been one of the major reasons for their reluctance to use wireless/mobile technologies within their Operational Technology (OT) communication architectures. This concern has repeatedly been brought up for 5G industrial use cases as well. Another important usage area is public safety where a robust design is even more essential.

One of the major factors relating to the critical communications is represented by anti-jamming capability, which has not been carefully considered up to now in a cellular communication system design. The traditional approach involves, firstly, detecting and locating the presence of a jammer, and then mitigating the interference of the jammer by using different anti-jamming means. The overall operation is implemented in a reactive manner. However, smart jammers can adapt their strategy by observing the reactions of a victim network. For example, the jammer can decide to increase its power if it does not observe a network reaction at all, or conversely, stop transmitting any signals so as not to be detected.

Therefore, instead of handling the smart jammers in a reactive manner, it is even better to provide built-in anti-jamming capability or resilience towards jamming from the very beginning of the 6G communication technology, i.e., in a proactive way, to make it impossible/much more difficult for the jammer to affect the operation of the whole communication system. In this regard, a PRACH is of particular interest since it is among the easiest communication channels to be attacked by the jammers. Up to now, information transmitted over the PRACH is completely open to any device who can read broadcast information. Given this, it is very easy even for a handheld smart jammer to attack the communication system via the PRACH.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that allows switching from public PRACH resources to secured PRACH resources, when needed (e.g., in case of a jamming attack on the public PRACH resources).

The objective above is achieved by the features of the independent claims in the appended claims. Further embodiments and examples are apparent from the dependent claims, the detailed description and the accompanying drawings.

According to a first aspect, a network node in a wireless communication network is provided. The network node comprises at least one processor and at least one memory. The at least one memory comprises a computer program code. The at least one memory and the computer program code are configured to, with the at least one processor, cause the network node to operate at least as follows. At first, the network node signals at least one public PRACH resource to at least one target (i.e., trusted) UE. Next, the network node signals at least one secured PRACH resource to each of the at least one target UE. Each of the at least one secured PRACH resource has an identifier (ID). Then, the network node signals the ID of an activated secured PRACH resource of the at least one secured PRACH resource to each of the at least one target UE. The activated secured PRACH resource is applicable instead of the at least one public PRACH resource. After that, the network node monitors a PRACH preamble from each of the at least one target UE based on the at least one public PRACH resource or the activated secured PRACH resource. By dividing all PRACH resources into the public set of PRACH resources (available for all UEs) and the secured set of PRACH resources (available only for the target or trusted UEs), the network node may allow the target UE(s) to perform public-to-secured PRACH resource switching, when needed, thereby providing secured communications between the target UE(s) and the network node (or any other network nodes). Furthermore, signaling the at least one secured PRACH resource takes more resources than signaling the ID of the activated secured PRACH resource. This is because the PRACH resource configuration includes many parameters while the ID is just one number. Therefore, it is beneficial to signal the at least one secured PRACH resource infrequently, while allowing flexibility with more frequent signaling for activating a certain secured PRACH resource. It is then feasible to use Radio Resource Control (RRC) signaling for signaling the secured PRACH resource, while the activation of a certain secured PRACH resource may be done by using physical layer or Medium Access Control (MAC) layer signaling.

In one example embodiment of the first aspect, the at least one memory and the computer program code are further configured to, with the at least one processor, cause the network node to signal, together with the ID of the activated secured PRACH resource, an indication that each of the at least one target UE is allowed to: (i) initiate a Random Access (RA) procedure based on the activated secured PRACH resource; or (ii) initiate the RA procedure based on the at least one public PRACH resource, and switch from the at least one public PRACH resource to the activated secured PRACH resource if the RA procedure based on the at least one public PRACH resource is unsuccessful. This indication may provide flexibility in deciding on the use of the PRACH resources on the UE side.

In one example embodiment of the first aspect, the at least one memory and the computer program code are further configured to, with the at least one processor, cause the network node to signal the at least one secured PRACH resource in an encrypted message. In this embodiment, the encrypted message is encrypted using an encryption key that is pre-known to each of the at least one target UE (e.g., for public safety UEs, the encryption key may be set before any network connection, or the target UE(s) may be pre-configured to use the encryption key over a secured communication channel between the network node and the target UE(s)). By using the encrypted message, the chance of a malicious UE learning about the secured PRACH resource(s) may be minimized.

In one example embodiment of the first aspect, the at least one memory and the computer program code are configured to, with the at least one processor, cause the network node to signal the activated secured PRACH resource in response to a jamming attack on the at least one public PRACH resource. In this embodiment, the target UE(s) may immediately (upon receiving the activated secured PRACH resource) to switch from the public PRACH resource(s) to the activated secured PRACH resource, thereby minimizing the possibility of further jamming. This is because the jamming of the secured PRACH resources is difficult as those may be found only by performing a blind search of PRACH preambles transmitted by the target UE. This is practically impossible as it would require scanning with a PRACH receiver over the whole time, frequency, preamble format and signature space. Thus, a malicious UE or, in other words, jammer would need to include such a preamble searching function and run it extensively before being able to discover the secured PRACH resources configured by the network node. Furthermore, the secured PRACH resources are randomly selected by the network node, this makes the discovery of the secured PRACH resources even more demanding.

In one example embodiment of the first aspect, the at least one secured PRACH resource is valid within a geographical area comprising one or more cells (e.g., within a Radio Access Network (RAN) Notification Area (RNA) pre-configured for the target UE(s)). If the target UE moves rapidly from one geographical area to another, the discovery of the secured PRACH resources for a given cell within a given geographical area will be even more problematic for the malicious UE. Another benefit provided by this embodiment is that when a target UE has received the signaling of the at least one secured PRACH resource through cell 1 and the same signaling is valid also for cell 2, the target UE may move from cell 1 to cell 2 and use the secured PRACH resource in cell 2 after receiving the activation indication from cell 2 and before making a secure connection to cell 2 using the public PRACH resources. This way, the UE may connect to a cell that is under a jamming attack that has made the public PRACH resources unusable in the cell.

In one example embodiment of the first aspect, the ID of the activated secured PRACH resource comprises at least one of: a format of the PRACH preamble; a system frame and subframe at which the PRACH preamble is to be transmitted; a time-domain location for the PRACH preamble; a frequency-domain location for the PRACH preamble; and a logical root sequence index. By using such an ID of the activated secured PRACH resource, it is possible to “hide” the activated secured PRACH resource from the malicious UE more efficiently.

In one example embodiment of the first aspect, the at least one memory and the computer program code are further configured to, with the at least one processor, cause the network node to signal, together with the activated secured PRACH resource, a time duration within which the activated secured PRACH resource is valid. In other words, the network node may indicate how long a certain PRACH configuration defined by one or more secured PRACH resources is to be active. This may minimize the chance of the malicious UE (e.g., the jammer) learning about the activated secured PRACH resource even more since the malicious UE will have a limited amount of time to find the activated secured PRACH resource. Additionally, by using a timer for the activation of certain secured PRACH resources, it is possible to efficiently adjust PRACH resource allocation in the wireless communication network.

According to a second aspect, a UE in a wireless communication network is provided. The UE comprises at least one processor and at least one memory. The at least one memory comprises a computer program code. The at least one memory and the computer program code are configured to, with the at least one processor, cause the UE to operate at least as follows. At first, the UE receives, from a network node or another UE, at least one public Physical Random Access Channel (PRACH) resource. Next, the UE receives, from the network node, another network node or another UE, at least one secured PRACH resource each having an ID. Further, the UE receives, from the network node, said another network node or said another UE, the ID of an activated secured PRACH resource of the at least one secured PRACH resource. The activated secured PRACH resource is applicable instead of the at least one public PRACH resource. After that, the UE starts transmitting a PRACH preamble to the network node or said another network node based on of the at least one public PRACH resource or the activated secured PRACH resource. By using the PRACH resources divided into the public set of PRACH resources (available for all UEs) and the secured set of PRACH resources (available only for the target or trusted UEs), the UE may perform public-to-secured PRACH resource switching, when needed, thereby providing secured communications between the UE and the network node (or any other network nodes). Furthermore, signaling the at least one secured PRACH resource takes more resources than signaling the ID of the activated secured PRACH resource. This is because the PRACH resource configuration includes many parameters while the ID is just one number. Therefore, it is beneficial to signal the at least one secured PRACH resource infrequently, while allowing flexibility with more frequent signaling for activating a certain secured PRACH resource. It is then feasible to use RRC signaling for signaling the secured PRACH resource, while the activation of a certain secured PRACH resource may be done by using physical layer or MAC layer signaling.

In one example embodiment of the second aspect, the at least one memory and the computer program code are further configured to, with the at least one processor, cause the UE to receive, together with the ID of the activated secured PRACH resource, an indication that the UE is allowed to: (i) initiate an RA procedure based on the activated secured PRACH resource; or (ii) initiate the RA procedure based on the at least one public PRACH resource, and switch from the at least one public PRACH resource to the activated secured PRACH resource if the RA procedure based on the at least one public PRACH resource is unsuccessful. This indication may provide flexibility in deciding on the use of the PRACH resources on the UE side.

In one example embodiment of the second aspect, the at least one memory and the computer program code are further configured to, with the at least one processor, cause the UE to receive the at least one secured PRACH resource in an encrypted message. In this embodiment, the encrypted message is encrypted using an encryption key that is pre-known to the UE (e.g., if the UE is a public safety UE, the encryption key may be set before any network connection, or the UE may be pre-configured to use the encryption key over a secured communication channel between the network node and the UE). By using the encrypted message, the chance of a malicious UE learning about the secured PRACH resource(s) may be minimized.

In one example embodiment of the second aspect, the at least one secured PRACH resource is valid within a geographical area comprising one or more cells (e.g., within an RNA pre-configured for the UE). If the UE moves rapidly from one geographical area to another, the discovery of the secured PRACH resources, e.g., for a given cell within a given geographical area will be even more problematic for the malicious UE. Another benefit provided by this embodiment is that when a target UE has received the signaling of the at least one secured PRACH resource through cell 1 and the same signaling is valid also for cell 2, the target UE may move from cell 1 to cell 2 and use the secured PRACH resource in cell 2 after receiving the activation indication from cell 2 and before making a secure connection to cell 2 using the public PRACH resources. This way, the UE may connect to a cell that is under a jamming attack that has made the public PRACH resources unusable in the cell.

In one example embodiment of the second aspect, the ID of the activated secured PRACH resource comprises at least one of: a format of the PRACH preamble; a system frame and subframe at which the PRACH preamble is to be transmitted; a time-domain location for the PRACH preamble; a frequency-domain location for the PRACH preamble; and a logical root sequence index. By using such IDs of the secured PRACH resources, it is possible to “hide” the secured PRACH resources from the malicious UE (e.g., the jammer) more efficiently.

In one example embodiment of the second aspect, the at least one memory and the computer program code are further configured to, with the at least one processor, cause the UE to receive, together with the ID of the activated secured PRACH resource, a time duration within which the activated secured PRACH resource is valid. By using the time duration (or, in other words, a timer) for the activated secured PRACH resource, it is possible to minimize the chance of the malicious UE learning about the activated secured PRACH resource even more since the malicious UE will have a limited amount of time to find the activated secured PRACH resource. Additionally, by using the timer for the activation of certain secured PRACH resources, it is possible to efficiently adjust PRACH resource allocation in the wireless communication network.

According to a third aspect, a method for operating a network node in a wireless communication network is provided. The method starts with the step of signaling at least one public PRACH resource to at least one target UE. Next, the method proceeds to the step of signaling at least one secured PRACH resource to each of the at least one target UE. Each of the at least one secured PRACH resource has an ID. Then, the method proceeds to the step of signaling the ID of an activated secured PRACH resource of the at least one secured PRACH resource. The activated secured PRACH resource is applicable instead of the at least one public PRACH resource. After that, the method goes on to the step of monitoring a PRACH preamble from each of the at least one target UE based on the at least one public PRACH resource or the activated secured PRACH resource. By dividing all PRACH resources into the public set of PRACH resources (available for all UEs) and the secured set of PRACH resources (available only for the target or trusted UEs), the network node may allow the target UE(s) to perform public-to-secured PRACH resource switching, when needed, thereby providing secured communications between the target UE(s) and the network node (or any other network nodes). Furthermore, signaling the at least one secured PRACH resource takes more resources than signaling the ID of the activated secured PRACH resource. This is because the PRACH resource configuration includes many parameters while the ID is just one number. Therefore, it is beneficial to signal the at least one secured PRACH resource infrequently, while allowing flexibility with more frequent signaling for activating a certain secured PRACH resource. It is then feasible to use RRC signaling for signaling the secured PRACH resource, while the activation of a certain secured PRACH resource may be done by using physical layer or MAC layer signaling.

According to a fourth aspect, a method for operating a UE in a wireless communication network is provided. The method starts with the step of receiving, from a network node, at least one public PRACH resource. Next, the method proceeds to the step of receiving, from the network node, another network node or another UE, at least one secured PRACH resource each having an ID. The method further proceeds to the step of receiving, from the network node, said another network node or said another UE, the ID of an activated secured PRACH resource of the at least one secured PRACH resource. The activated secured PRACH resource is applicable instead of the at least one public PRACH resource. After that, the method proceeds to the step of transmitting a PRACH preamble to the network node or said another network node based on the at least one public PRACH resource or the activated secured PRACH resource. By using the PRACH resources divided into the public set of PRACH resources (available for all UEs) and the secured set of PRACH resources (available only for the target or trusted UEs), the UE may perform public-to-secured PRACH resource switching, when needed, thereby providing secured communications between the UE and the network node (or any other network nodes). Furthermore, signaling the at least one secured PRACH resource takes more resources than signaling the ID of the activated secured PRACH resource. This is because the PRACH resource configuration includes many parameters while the ID is just one number. Therefore, it is beneficial to signal the at least one secured PRACH resource infrequently, while allowing flexibility with more frequent signaling for activating a certain secured PRACH resource. It is then feasible to use RRC signaling for signaling the secured PRACH resource, while the activation of a certain secured PRACH resource may be done by using physical layer or MAC layer signaling.

According to a fifth aspect, a network node in a wireless communication network is provided. The network node comprises a means for signaling at least one public PRACH resource to at least one target UE. The network node further comprises a means for signaling at least one secured PRACH resource to each of the at least one target UE. Each of the at least one secured PRACH resource has an ID. The network node further comprises a means for signaling the ID of an activated secured PRACH resource of the at least one secured PRACH resource to each of the at least one target UE. The network node further comprises a means for monitoring a PRACH preamble from each of the at least one target UE based on the at least one public PRACH resource or the activated secured PRACH resource. By dividing all PRACH resources into the public set of PRACH resources (available for all UEs) and the secured set of PRACH resources (available only for the target or trusted UEs), the network node may allow the target UE(s) to perform public-to-secured PRACH resource switching, when needed, thereby providing secured communications between the target UE(s) and the network node (or any other network nodes). Furthermore, signaling the at least one secured PRACH resource takes more resources than signaling the ID of the activated secured PRACH resource. This is because the PRACH resource configuration includes many parameters while the ID is just one number. Therefore, it is beneficial to signal the at least one secured PRACH resource infrequently, while allowing flexibility with more frequent signaling for activating a certain secured PRACH resource. It is then feasible to use RRC signaling for signaling the secured PRACH resource, while the activation of a certain secured PRACH resource may be done by using physical layer or MAC layer signaling.

According to a sixth aspect, a UE in a wireless communication network is provided. The UE comprises a means for receiving, from a network node, at least one public PRACH resource. The UE further comprises a means for receiving, from the network node, another network node or another UE, at least one secured PRACH resource each having an ID. The UE further comprises a means for receiving the ID of an activated secured PRACH resource of the at least one secured PRACH resource. The activated secured PRACH resource is applicable instead of the at least one public PRACH resource. The UE further comprises a means for transmitting a PRACH preamble to the network node or said another network node based on the at least one public PRACH resource or the activated secured PRACH resource. By using the PRACH resources divided into the public set of PRACH resources (available for all UEs) and the secured set of PRACH resources (available only for the target or trusted UEs), the UE may perform public-to-secured PRACH resource switching, when needed, thereby providing secured communications between the UE and the network node (or any other network nodes). Furthermore, signaling the at least one secured PRACH resource takes more resources than signaling the ID of the activated secured PRACH resource. This is because the PRACH resource configuration includes many parameters while the ID is just one number. Therefore, it is beneficial to signal the at least one secured PRACH resource infrequently, while allowing flexibility with more frequent signaling for activating a certain secured PRACH resource. It is then feasible to use RRC signaling for signaling the secured PRACH resource, while the activation of a certain secured PRACH resource may be done by using physical layer or MAC layer signaling.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a block diagram of a network node in accordance with one example embodiment;

FIG. 2 shows a flowchart of a method for operating the network node of FIG. 1 in accordance with one example embodiment;

FIG. 3 shows a possible PRACH resource allocation in accordance with one example embodiment;

FIG. 4 shows a block diagram of a UE in accordance with one example embodiment;

FIG. 5 shows a flowchart of a method for operating the UE of FIG. 4 in accordance with one example embodiment;

FIG. 6 shows a flowchart of a method for performing public-to-secured PRACH resource switching at the UE of FIG. 4 in accordance with one example embodiment;

FIG. 7 explains how the UE of FIG. 4 may switch between the public PRACH resources and the secured PRACH resources in case of using a validity period for the secured PRACH resources in accordance with one example embodiment;

FIG. 8 shows a flowchart of a method for performing the public-to-secured PRACH resource switching at the UE of FIG. 4 in accordance with another example embodiment;

FIG. 9 shows a signaling diagram between a gNB and a UE for configuring, activation and use of secured PRACH resources in accordance with a first example embodiment;

FIG. 10 shows a signaling diagram between two gNBs and a UE for configuring, activation and use of secured PRACH resources in accordance with a second example embodiment; and

FIG. 11 shows a signaling diagram between two gNBs and two UEs for configuring, activation and use of secured PRACH resources in accordance with a third example embodiment.

### DETAILED DESCRIPTION

Various embodiments of the present disclosure are further described in more detail with reference to the accompanying drawings. However, the present disclosure can be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatuses and methods disclosed herein can be implemented in practice by using any numbers of the embodiments provided herein. Furthermore, it should be understood that any embodiment of the present disclosure can be implemented using one or more of the elements presented in the appended claims.

Unless otherwise stated, any embodiment recited herein as “example embodiment” should not be construed as preferable or having an advantage over other embodiments.

Although the numerative terminology, such as “first”, “second”, etc., may be used herein to describe various embodiments, elements or features, these embodiments, elements or features should not be limited by this numerative terminology. This numerative terminology is used herein only to distinguish one embodiment, element or feature from another embodiment, element or feature. Thus, a first embodiment discussed below could be called a second embodiment, and vice versa, without departing from the teachings of the present disclosure.

According to the example embodiments disclosed herein, a User Equipment (UE) may refer to an electronic computing device that is configured to perform wireless communications. The UE may be implemented as a mobile station, a mobile terminal, a mobile subscriber unit, a mobile phone, a cellular phone, a smart phone, a cordless phone, a personal digital assistant (PDA), a wireless communication device, a desktop computer, a laptop computer, a tablet computer, a gaming device, a netbook, a smartbook, an ultrabook, a medical mobile device or equipment, a biometric sensor, a wearable device (e.g., a smart watch, smart glasses, a smart wrist band, etc.), an entertainment device (e.g., an audio player, a video player, etc.), a vehicular component or sensor (e.g., a driver-assistance system), a smart meter/sensor, an unmanned vehicle (e.g., an industrial robot, a quadcopter, etc.) and its component (e.g., a self-driving car computer), industrial manufacturing equipment, a global positioning system (GPS) device, an Internet-of-Things (IoT) device, an Industrial IoT (IIoT) device, a machine-type communication (MTC) device, a group of Massive IoT (MIoT) or Massive MTC (mMTC) devices/sensors, or any other suitable mobile device configured to support wireless communications. In some embodiments, the UE may refer to at least two collocated and inter-connected UEs thus defined.

As used in the example embodiments disclosed herein, a network node may refer to a fixed point of communication/communication node for a UE in a particular wireless communication network. More specifically, the network node may be used to connect the UE to a Data Network (DN) through a Core Network (CN) and may be referred to as a base transceiver station (BTS) in terms of the 2G communication technology, a NodeB in terms of the 3G communication technology, an evolved NodeB (eNodeB or eNB) in terms of the 4G communication technology, and a gNB in terms of the 5G New Radio (NR) communication technology. The network node may serve different cells, such as a macrocell, a microcell, a picocell, a femtocell, and/or other types of cells. The macrocell may cover a relatively large geographic area (e.g., at least several kilometers in radius). The microcell may cover a geographic area less than two kilometers in radius, for example. The picocell may cover a relatively small geographic area, such, for example, as offices, shopping malls, train stations, stock exchanges, etc. The femtocell may cover an even smaller geographic area (e.g., a home). Correspondingly, the network node serving the macrocell may be referred to as a macro node, the network node serving the microcell may be referred to as a micro node, and so on.

According to the example embodiments disclosed herein, a wireless communication network, in which a UE and a network node communicate with each other, may refer to a cellular or mobile network, a Wireless Local Area Network (WLAN), a Wireless Personal Area Networks (WPAN), a Wireless Wide Area Network (WWAN), a satellite communication (SATCOM) system, or any other type of wireless communication networks. Each of these types of wireless communication networks supports wireless communications according to one or more communication protocol standards. For example, the cellular network may operate according to the Global System for Mobile Communications (GSM) standard, the Code-Division Multiple Access (CDMA) standard, the Wide-Band Code-Division Multiple Access (WCDM) standard, the Time-Division Multiple Access (TDMA) standard, or any other communication protocol standard, the WLAN may operate according to one or more versions of the IEEE 802.11 standards, the WPAN may operate according to the Infrared Data Association (IrDA), Wireless USB, Bluetooth, or ZigBee standard, and the WWAN may operate according to the Worldwide Interoperability for Microwave Access (WiMAX) standard.

If a UE wants or needs to create an initial connection with a network node, it may use a Random Access Channel (RACH) procedure. This is one of the common procedures present in all the earlier versions of wireless communication networks, including Global System for Mobile communication (GSM), General Packet Radio Service (GPRS), Universal Mobile Telecommunications Service (UMTS) and Long-Term Evolution (LTE), with some changes in messages exchanged between the UE and the network node. The RACH procedure is done for many different reasons: the UE wants to connect for outgoing call/data; the UE responds to paging for incoming call/data; handover to a new cell; beam recovery; etc. During the RACH procedure, the UE selects a preamble (i.e., a code sequence) and sends it (as Message 1 or Msg1) using some pre-reserved time-frequency resources (which are called RACH Occasions (ROs) in terms of the 5G technology) on an uplink channel called a Physical RACH (PRACH). Then, the UE starts monitoring a downlink channel to see if the network node answers the UE request to connect to the wireless communication network. If not, the UE will make a new attempt with an increased power. A Random Access Response (RAR) (i.e., Message 2 or Msg2) sent by the network node indicates which preamble it is related to, a Timing Advance (TA) it should use, a scheduling grant for sending a scheduled PUSCH transmission (i.e., Message 3 or Msg3) and a Temporary Cell Radio Network Temporary Identifier (TC-RNTI). The Msg3 may carry a Radio Resource Control (RRC) request that is sent by the UE to the network node over a scheduled PUSCH with an ID for contention resolution. In response to the Msg3, the network node sends a Message 4 or Msg4 to the UE, which may include an RRC setup that carries a contention resolution message with the contention-resolution ID. Upon reception of the Msg4, the UE sends an acknowledgement (ACK) message on a Physical Uplink Control Channel (PUCCH) if its contention-resolution ID is carried by the Msg4. After that, the RACH procedure is completed, and the UE moves to an RRC connected state and the data communication between the UE and the network node may continue using a normal dedicated transmission. The aforesaid relates to the 4-step RACH procedure. There is also the 2-step RACH procedure which is similar to the 4-step RACH procedure, but the information contents of the Msg1 and the Msg3 are carried in one or more MsgA transmissions without waiting for feedback from the UE in between (i.e., the Msg2); similarly, the information contents of the Msg2 and the Msg4 are carried in one or more MsgB transmissions from the network node.

In the 4G and 5G communication technologies, all PRACH resources are indicated in broadcasted system information. A malicious UE can read this information and start, for example, jamming the PRACH resources. Jamming only the PRACH is an efficient way of blocking a band: learning where the PRACH resources are located in the time and frequency domain is a normal UE procedure and their jamming can be limited to transmissions on only certain sparce time-frequency resources, thereby making it more difficult to pinpoint the malicious UE. This problem exists both with the contention-based and contention-free (4-step or 2-step) RACH procedures as the overall PRACH resources are the same in both RACH procedures, and for the contention-free RACH procedure, a UE is provided with a subset of the overall PRACH resources with Downlink Control Information (DCI). Therefore, jamming all the PRACH resources also blocks the contention-free RACH procedure.

To mitigate or even eliminate the above-indicated problems, the present authors have decided to introduce the concept of hidden or, in other words, secured PRACH resources to build a high-reliable high-secured PRACH framework (including anti-jamming capability for the PRACH). This concept involves using at least two following types of the PRACH resources:
(1) public PRACH resources that are configured by a network node using plaintext broadcasted system information and therefore available for all UEs; and
(2) hidden or secured PRACH resources that are available only for trusted UEs (herein also referred to as target UEs). In other words, the information on the secured PRACH resource configuration is not just “distributed to any UE who cares”, but only to a certain (e.g., user-defined) subset of UEs among all UEs present in a wireless communication network. For example, the target UEs may refer to public safety UEs. The secured PRACH resources may be configured by the network node using one or more encrypted (e.g., RRC) messages. It is assumed that the target UEs are preliminarily provided with encryption keys to retrieve information from the encrypted messages. For example, the encryption keys may be provided by the network node to the target UE(s) via a certain protocol layer, such as Packet Data Convergence Protocol (PDCP) layer, when the UEs were last in an RRC connected state. Alternatively, the target UE(s) may be configured to use the encryption keys by default (e.g., according to a factory setting) or by a user. As one more alternative, the encryption keys and/or the secured PRACH resources may be provided to the target UE from another UE over, for example, a sidelink or another connectivity technology.

Given the above, the example embodiments disclosed herein provide a technical solution that allows the PRACH resources to be configured such that they are less accessible to malicious UEs (e.g., less prone to jamming). For this purpose, all PRACH resources are divided into a set of public PRACH resources and a set of secured PRACH resources, which are both configured by a network node for one or more target UEs. Each of the secured PRACH resources has an ID. A network node may any time indicate that a certain secured PRACH resource is available or activated in a cell but, in particular, the indication may take place when it is detected that public PRACH resources are subjected to a jamming attack. In this situation, the network node may indicate that one or more secured PRACH resources among the set of configured secured PRACH resources is(are) activated. The ID(s) of the activated secured PRACH resource(s) is(are) signaled by the network node to the target UE(s) (e.g., by using a plaintext broadcast message). After that, the UE may start transmitting a PRACH preamble to the network node by using the activated secured PRACH resource(s). After the network node has indicated that some of the secured PRACH resources are activated, the alternatives are that the target UE(s): (1) should use the activated secured PRACH resource(s) for the PRACH transmission; or (2) is(are) allowed to choose between the public PRACH resources and the activated secured PRACH resources. The alternative (2) would allow the target UE(s) to try a Random Access (RA) procedure using the public PRACH resources and, only if the RA procedure is not successful, start checking whether any of the secured PRACH resources is(are) activated. The alternative (2) would also allow the target UE to start the RA procedure using the public PRACH resources and simultaneously searching for the activated secured PRACH resource(s), and, if the target UE finds the activated secured PRACH resource(s), the target UE may choose to continue the started RA procedure or start a new RA procedure using the activated secured PRACH resource(s). It should be also noted that each target UE may be pre-configured to follow any of the above-indicated alternatives (1) and (2) by default (e.g., according to a factory setting).

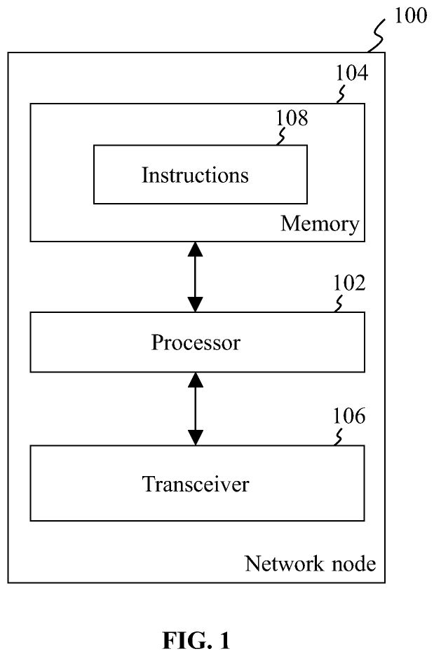

FIG. 1 shows a block diagram of a network node 100 in accordance with one example embodiment. The network node 100 is intended to communicate with one or more UEs in any of the above-described wireless communication networks. As shown in FIG. 1, the network node 100 comprises a processor 102, a memory 104, and a transceiver 106. The memory 104 stores processor-executable instructions 108 which, when executed by the processor 102, cause the processor 102 to perform the aspects of the present disclosure, as will be described below in more detail. It should be noted that the number, arrangement, and interconnection of the constructive elements constituting the network node 100, which are shown in FIG. 1, are not intended to be any limitation of the present disclosure, but merely used to provide a general idea of how the constructive elements may be implemented within the network node 100. For example, the processor 102 may be replaced with several processors, as well as the memory 104 may be replaced with several removable and/or fixed storage devices, depending on particular applications. Furthermore, in some embodiments, the transceiver 106 may be implemented as two individual devices, with one for a receiving operation and another for a transmitting operation. Irrespective of its implementation, the transceiver 106 is intended to be capable of performing different operations required to perform the data reception and transmission, such, for example, as signal modulation/demodulation, encoding/decoding, etc. In other embodiments, the transceiver 106 may be part of the processor 102 itself.

The processor 102 may be implemented as a CPU, general-purpose processor, single-purpose processor, microcontroller, microprocessor, application specific integrated circuit (ASIC), field programmable gate array (FPGA), digital signal processor (DSP), complex programmable logic device, etc. It should be also noted that the processor 102 may be implemented as any combination of one or more of the aforesaid. As an example, the processor 102 may be a combination of two or more microprocessors.

The memory 104 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

The processor-executable instructions 108 stored in the memory 104 may be configured as a computer-executable program code which causes the processor 102 to perform the aspects of the present disclosure. The computer-executable program code for carrying out operations or steps for the aspects of the present disclosure may be written in any combination of one or more programming languages, such as Java, C++, or the like. In some examples, the computer-executable program code may be in the form of a high-level language or in a pre-compiled form and be generated by an interpreter (also pre-stored in the memory 104) on the fly.

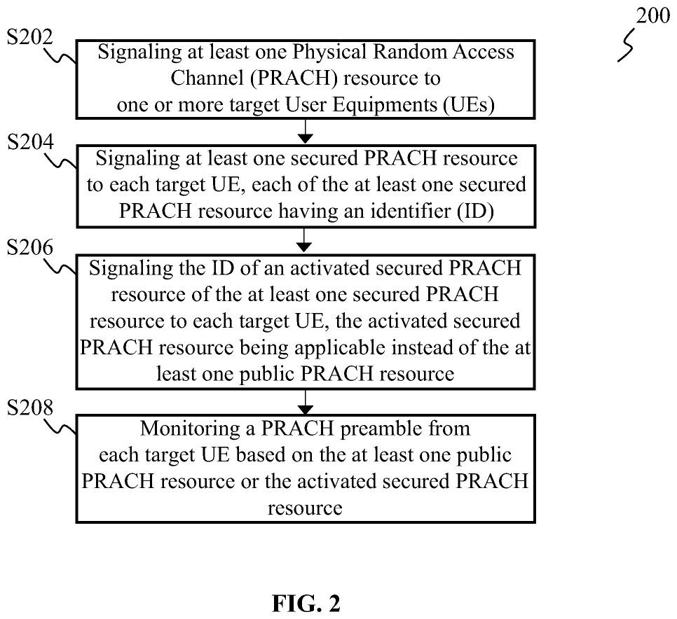

FIG. 2 shows a flowchart of a method 200 for operating the network 100 in accordance with one example embodiment.

The method 200 starts with a step S202, in which the processor 102 signals (e.g., via the transceiver 106) one or more public PRACH resources to one or more target UEs. The step S202 may be performed by using any broadcast signaling.

Next, the method 200 proceeds to a step S204, in which processor 102 signals (e.g., via the transceiver 106) one or more secured PRACH resources to the target UE(s). This step may be done by using any dedicated signaling (e.g., RRC signaling). Furthermore, the secured PRACH resource(s) may be signaled in an encrypted message that is generated by the processor 102 by using an encryption key pre-known to the target UE(s), so that the target UE(s) may properly decrypt the encrypted message and retrieve the information about the secured PRACH resource(s). Each secured PRACH resource is provided with an ID. Each secured PRACH resource may be cell specific. Additionally, the secured PRACH resource(s) may be valid within a certain geographical area comprising one or more cells (e.g., within a certain Radio Access Network (RAN) Notification Area (RNA) within which each cell may use different one or more secured PRACH resources). This may allow tuning the capacity of the secured PRACH resources in a cell specific manner. By varying the PRACH resource allocation/configuration between cells, it is possible to make the search of the secured PRACH resources by a malicious UE (e.g., a jammer) more difficult as the PRACH resources revealed for a given cell would not necessarily apply to a neighboring cell. Moreover, if a target UE exits the RNA, then a new set of secured PRACH resources may be applied, thereby making it extremely difficult for the malicious UE to track such changes in the secured PRACH resources. If the secured PRACH resource(s) is(are) valid over multiple cells, the target UE that has received the signaling of the secured PRACH resource(s) through one cell may, by utilizing the secured PRACH resource(s) of another cell, connect to said another cell even if said another cell is under a jamming attack on the public PRACH resource(s).

As for the ID of each secured PRACH resource, it may be represented by one or more PRACH parameters. It should be noted that some of the PRACH parameters, like a preamble power and a corresponding response window, may be common for both public and secured PRACH resources. This is because knowing them would not make it easier for the malicious UE to find the secured PRACH resources. At the same time, the PRACH parameters important for hiding the secured PRACH resources from the malicious UE may comprise:
a type or format of a PRACH preamble (usually indicated in “PRACH-ConfigurationIndex” parameter that is typically used for PRACH preamble generation);
an index of the PRACH preamble;
a system frame and subframe at which the PRACH preamble is to be transmitted (also indicated in “PRACH-ConfigurationIndex” parameter);
a frequency-domain location for the PRACH preamble, which may represented by one or more of the following parameters normally indicated in “RACH-ConfigGeneric” parameter: “msg1-FDM” (i.e., a number of PRACH transmission occasions multiplexed in the frequency domain within one time instance), “msg1-FrequencyStart” (i.e., an offset of the lowest PRACH transmission occasion in the frequency domain with respective to Physical Resource Block (PRB) 0), and “zeroCorrelationZoneConfig” (i.e., a number of Root Sequences required per cell for the selected PRACH); and
a logical root sequence index (known as “PRACH-RootSequenceIndex” parameter used for the PRACH preamble generation and normally included in “RACH-ConfigCommon” parameter).

The above-indicated PRACH parameters are well-known in the art, whereupon their detailed description is omitted herein. One or more of these PRACH parameters would be beneficial to use as the ID of each secured PRACH resource (e.g., signaled in the encrypted message), i.e., one or more of these PRACH parameters are associated with the ID.

In one embodiment, the processor 102 may additionally signal (e.g., via the transceiver 106), together with the secured PRACH resource(s), one or more PUSCH resource for each secured PRACH resource. The joint use of the secured PRACH resource(s) and the PUSCH resource(s) may be especially beneficial in case of the scenarios associated with the 2-step RACH procedure.

When the secured PRACH resource(s) has (have) been signaled to the target UE(s), the method 200 goes on to a step S206, in which the processor 102 signals (e.g., via the transceiver 106) the ID(s) of an activated secured PRACH resource(s) to the target UE(s). This step may be performed by using any broadcast signaling (e.g., Layer 1 (L1), Media Access Control (MAC), or System Information Block Type 1 (SIB1) signaling, etc.). There is no need to send the ID(s) of the activated secured PRACH resource(s) in an encrypted message-a simple plaintext message is sufficient for this purpose. The activated secured PRACH resource may be used by each target UE instead of the public PRACH resource(s) (if the public PRACH resource(s) is(are) detected to be under a malicious attack, for example). The step S206 may be performed, for example, if the processor 102 detects that the public PRACH resource(s) used by the target UE(s) to transmit the PRACH preamble to the network node 100 has been subjected to a jamming attack. The processor 102 may detect the jamming attack by purely observing the public PRACH resource(s). For example, an unexceptionally large power without any detected PRACH preambles may indicate the jamming attack. In general, if the normal RACH activity is “unexpected”—either too low amount of PRACH preambles or too high interference observed, —this may provide evidence of the jamming attack. Additionally or alternatively, the network node 100 may rely on kind of UE assistance to detect the jamming attack or any other malicious use of the public PRACH resource(s). As one example, if a UE (not necessarily a target UE) is Time Division Duplex (TDD)-capable (i.e., it may measure in the same band in which it normally transmits), the UE may potentially perform measurements in ROs that it is not using at the moment; in case of high interference in the ROs, the UE may collect this information and provide it to the network node 100 later for analysis. As another example, if the UE attempts to perform the RA procedure multiple times and knows that physical conditions should be sufficiently good, the UE may also collect this information and report this to the network node 100 later for analysis. In the above-given examples, the UE may provide the measurement information at a later time instant or try to convey the measurement information through other channels (e.g., through another UE/service (sidelink or similar)).

In the step S206, if the set of secured PRACH resources is pre-configured for the target UE(s), the processor 102 may select, among the set of secured PRACH resources, one or more secured PRACH resources to be activated for the target UE(s) (e.g., upon detecting the jamming attack). This selection may be made based on different selection metrics, such, for example, as follows: interference per RO, a number of RACH attempts, etc.

In one embodiment, the processor 102 may signal, together with the ID of the activated secured PRACH resource(s), an indication that each target UE is allowed to: (i) initiate an RA procedure based on the activated secured PRACH resource(s); or (ii) initiate the RA procedure based on the public PRACH resource(s), and switch from the public PRACH resource(s) to the activated secured PRACH resource(s) if the RA procedure based on the public PRACH resource(s) is unsuccessful. This may provide flexibility in the use of the PRACH resources on the UE side.

In additional or alternative embodiment, the processor 102 may signal, together with the ID of the activated secured PRACH resource(s), a time duration within which the activated secured PRACH resource(s) should be valid. In other words, the network node 100 may indicate a validity period for the activated secured PRACH resource(s). The validity period may be either a certain single time interval or recurring time interval (with a certain periodicity).

It should be also noted that the steps S204 and S206 may be combined into a single step, in which the processor 102 signals the whole set of secured PRACH resources together with the ID(s) of the activated secured PRACH resource(s) to each target UE by using a single encrypted message.

The method 200 ends up with a step S208, in which the processor 102 starts monitoring a PRACH preamble from each target UE based on the public PRACH resource(s) or the activated secured PRACH resource(s).

By using the method 200, the secured PRACH resource(s) may be configured for one or more target UEs, but it is not activated by default. Only if/when the network node 100 signals the ID(s) of the activated secured PRACH resource(s) (e.g., in response to the detection of the jamming attack), the target UE(s) is(are) allowed to use the activated secured PRACH resources (if configured). This way, it is possible to have the secured PRACH resources pre-configured, but not taking any network resources until they are actually needed (i.e., when the network node 100 decides that it is better to switch from the public PRACH resources to certain secured PRACH resources in response to the detection of the jamming attack).

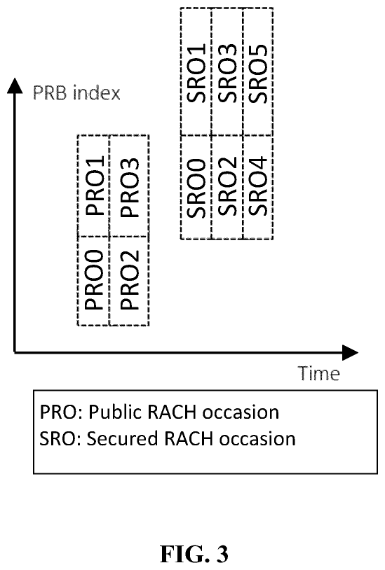

FIG. 3 shows a possible PRACH resource allocation in accordance with one example embodiment. As shown in FIG. 3, the overall PRACH resources are divided into two sets: one set of public PRACH resources available for all UEs at certain public RACH occasions (PROs), and another set of secured PRACH resources available only for target UEs at certain secured PRACH occasions (SROs). The set of secured PRACH resources is configured and reported to the target UEs in accordance with the method 200.

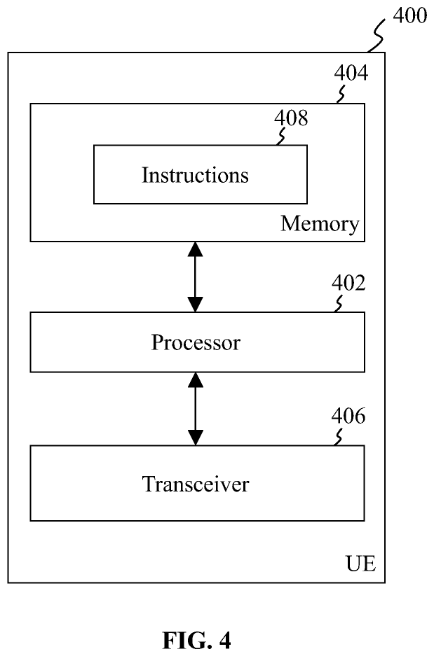

FIG. 4 shows a block diagram of a UE 400 in accordance with one example embodiment. The UE 400 is intended to communicate with the network node 100 in any of the above-described wireless communication networks. As shown in FIG. 4, the UE 400 comprises a processor 402, a memory 404, and a transceiver 406. The memory 404 stores processor-executable instructions 408 which, when executed by the processor 402, cause the processor 402 to implement the aspects of the present disclosure, as will be described below in more detail. It should be again noted that the number, arrangement, and interconnection of the constructive elements constituting the UE 400, which are shown in FIG. 4, are not intended to be any limitation of the present disclosure, but merely used to provide a general idea of how the constructive elements may be implemented within the UE 400. In general, the processor 402, the memory 404, the transceiver 406, and the processor-executable instructions 408 may be implemented in the same or similar manner as the processor 102, the memory 104, the transceiver 106, and the processor-executable instructions 108, respectively.

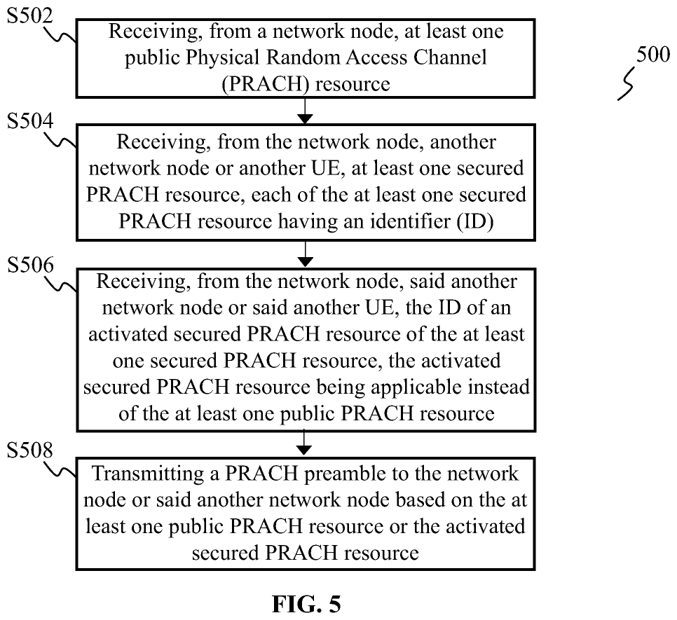

FIG. 5 shows a flowchart of a method 500 for operating the UE 400 in accordance with one example embodiment. The method 500 starts with a step S502, in which the processor 402 receives (e.g., via the transceiver 406), from the processor 102 of the network node 100, the public PRACH resource(s). Next, the method proceeds to a step S504, in which the processor 402 receives (e.g., via the transceiver 406), from the processor 102 of the network node 100, the secured PRACH resource(s) each having an ID. The ID may be represented by any one or more of the above-discussed PRACH parameters. As noted above, the secured PRACH resource(s) may be signaled in the encrypted message, and the UE 400 is assumed to be aware of the encryption key required to decrypt the encrypted message. The method 500 further proceeds to a step S506, in which the processor 402 receives (e.g., via the transceiver 406) the ID(s) of the activated secured PRACH resource(s) from the network node. The processor 402 may use the activated secured PRACH resource(s) instead of the public PRACH resource(s). It should be noted that the secured PRACH resource(s) and/or the activated secured PRACH resource(s) may also be signaled, in the steps S504 and S506, to the UE 400 from another UE or a network node different from the network node 100. The method 500 ends up with a step S508, in which the processor 402 transmits (e.g., via the transceiver 406) the PRACH preamble to the processor 102 of the network node 100 (or to any other network node) by using the public PRACH resource(s) or the activated secured PRACH resource(s).

In one embodiment, the configuration of the secured PRACH resource(s) may potentially be made such that the secured PRACH resource(s) is(are) available for the UE 400 even that it is entering an RRC idle state (RRC_IDLE). Such persistent configuration may be limited to certain cells or areas (e.g., certain one or more RNA). In one more embodiment, the activated secured PRACH resource(s) may also be valid during the validity period also signaled together with the ID(s) of the activated secured PRACH resource(s). As noted earlier, the validity period may refer to a certain single time interval or recurring time interval.

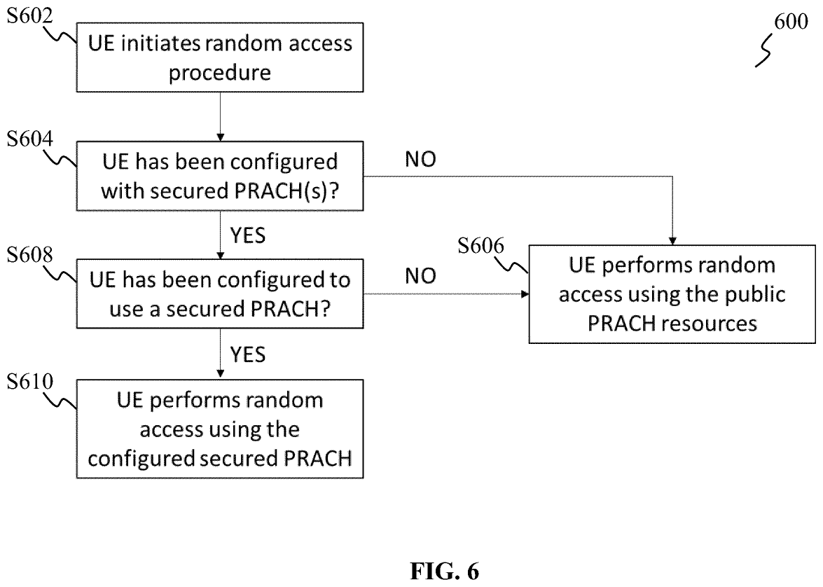

FIG. 6 shows a flowchart of a method 600 for performing public-to-secured PRACH resource switching at the UE 400 in accordance with one example embodiment. The method 600 starts with a step S602, in which the processor 402 of the UE 400 initiates the RACH procedure with the network node 100. In a next step S604, the processor 402 checks whether the UE 400 has been configured by the network node 100 with any set of secured PRACH resources (e.g., whether the UE 400 has received the above-described encrypted message). If the checking result is “NO”, then the method 600 proceeds to a step S606, in which the processor 402 performs the RACH procedure by using the public PRACH resource(s). If the checking result is “YES”, then the method 600 proceeds to a step S608, in which the processor 402 checks whether the UE 400 has been instructed by the network node 100 to use one or more activated secured PRACH resource(s) of the configured set of secured PRACH resources (i.e., whether the UE 400 has received the above-described plaintext message with the ID(s) of the activated secured PRACH resource(s)). If the checking result is “NO”, then the method 600 goes back to the step S606; otherwise (i.e., if the checking result is “YES”), the method 600 proceeds to a step S608, in which the processor 402 performs the RACH procedure by using the activated secured PRACH resource(s) instead of the public PRACH resource(s).

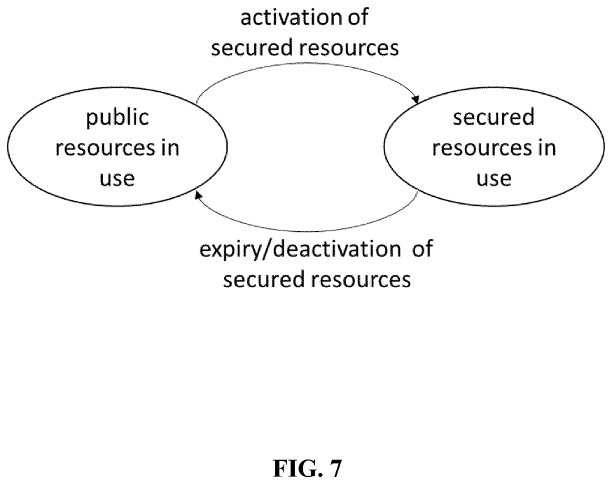

FIG. 7 explains how the UE 400 may switch between the public PRACH resource(s) and the activated secured PRACH resource(s) (i.e., those which are “in use”) in case of using a validity period for the secured PRACH resources in accordance with one example embodiment. If the above-mentioned plaintext message transmitted from the network node 100 to the UE 400 (in the step S206 of the method 200) indicates the validity period, then the UE 400 may trigger a timer corresponding to the validity period upon receiving the plaintext message. Once the timer expires, the UE 400 may switch from the activated secured PRACH resource(s) to the public PRACH resource(s). The UE 400 may repeatedly perform the public-to-secured PRACH resource switching and vice versa, provided that the validity period refers to a recurring time interval.

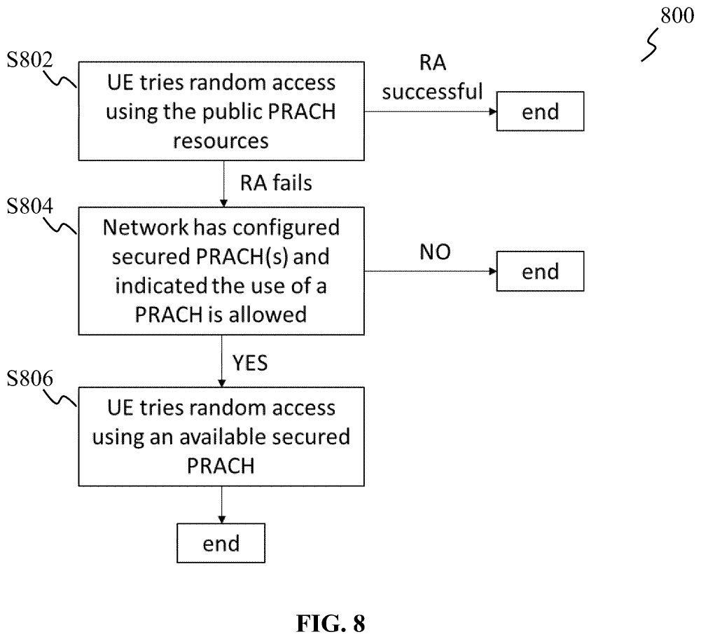

FIG. 8 shows a flowchart of a method 800 for performing public-to-secured PRACH resource switching at the UE 400 in accordance with another example embodiment. The method 800 starts with a step S802, in which the processor 402 starts performing the RACH procedure by using the public PRACH resource(s). In other words, the processor 402 starts sending the PRACH preamble to the processor 102 by using the public PRACH resource(s). This is in contrast to the method 600, according to which the UE 400 should initiate the RACH procedure but first check whether there is(are) secured PRACH resource(s) configured by the network node 100, and the public PRACH resource(s) is(are) used only when no secured PRACH resource has been configured (by using the encrypted message in the step S204 of the method 200) or activated (by using the plaintext message in the step S206 of the method 200). In the method 800, the processor 402 checks the presence of the secured PRACH resource(s) only after it has failed in the RACH procedure by using the public PRACH resources. Said failing means that the UE 400 has tried multiple PRACH preamble transmissions and/or has reached a maximum PRACH preamble transmission power. When such a failure occurs, the method 800 goes on to a step S804, in which the processor 402 checks whether there is at least one secured PRACH resource configured and activated for the UE 400. If the checking result is “YES”, the method 800 proceeds to a step S806, in which the processor 402 sends the PRACH preamble by using the available secured PRACH resource(s); if the checking result is “NO”, the method 800 ends.

It should be noted that, based on observations of the PRACH preamble transmissions on the preliminary secured PRACH resource(s), the network node 100 may (1) allocate more secured PRACH resources if the load on the preliminary PRACH resource(s) exceeds its (their) capacity, or (2) activate some secured PRACH resources to be directly available without the target UEs having to first try the PRACH preamble transmissions through the public PRACH resource(s).

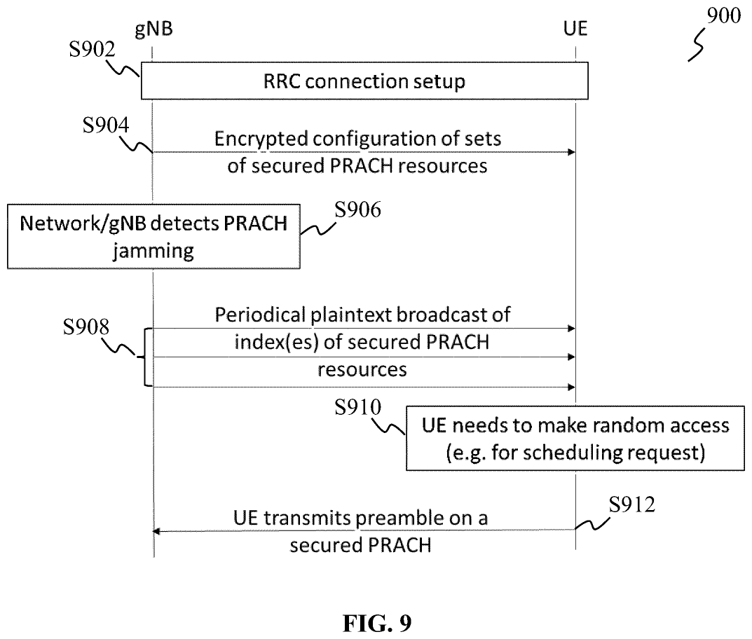

FIG. 9 shows a signaling diagram 900 between a gNB and a UE for configuring, activation and use of secured PRACH resources in accordance with a first example embodiment. In the signaling diagram 900, it is assumed that the gNB is implemented as the network node 100, and the UE is implemented as the UE 400. The signaling diagram 900 starts with a step S902, in which the UE establishes an RRC connection with the gNB. After the RRC connection is established (i.e., the UE is in RRC_CONNECTED state), a next step S904 is initiated, in which the gNB signals a set of secured PRACH resources to the UE by using one or more encrypted messages. Then, the signaling diagram 900 goes on to a step S906, in which the gNB detects a jamming attack on a set of public PRACH resources currently used by the UE. In response to the jamming attack, the gNB starts periodically sending one or more plaintext broadcast messages to the UE. The plaintext broadcast message comprises one or more IDs (e.g., “PRACH-ConfigurationIndex”) of secured PRACH resources selected (and activated) by the gNB from the set of secured PRACH resources for further use for the PRACH preamble transmission. Further, the signaling diagram 900 goes on to steps S910 and S912, in which the UE first initiates random access and transmits a PRACH preamble to the gNB by using the selected secured PRACH resource(s).

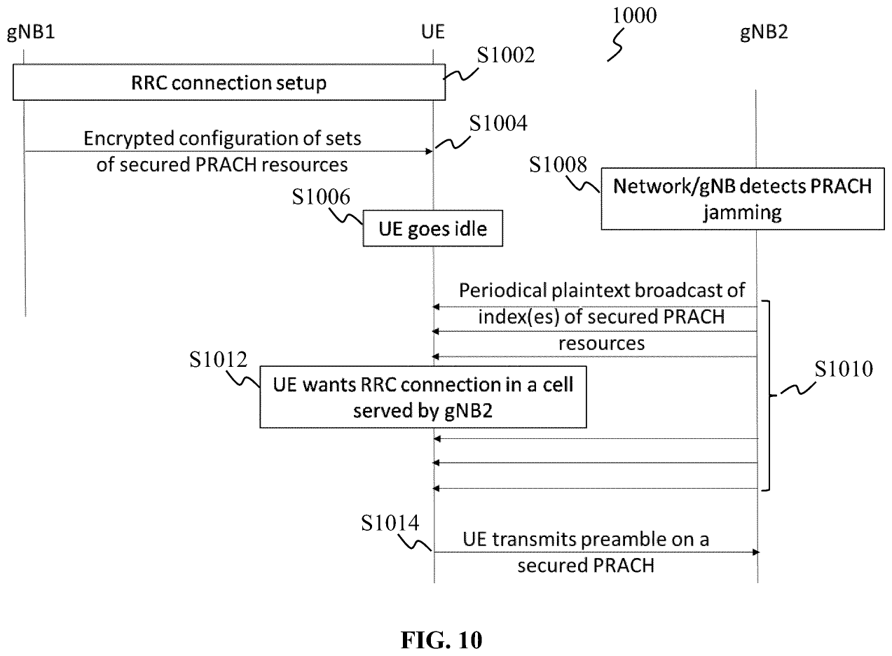

FIG. 10 shows a signaling diagram 1000 between two gNBs and a UE for configuring, activation and use of secured PRACH resources in accordance with a second example embodiment. In the signaling diagram 1000, it is assumed that each of gNB1 and gNB2 is implemented as the network node 100, and the UE is implemented as the UE 400. The signaling diagram 1000 may be used in scenarios when a set of secured PRACH resources is valid for a given NRA, so that the UE may obtain the set of secured PRACH resources through one gNB and applies it later to connect to another gNB that is under a jamming attack and located in the same RNA. The signaling diagram 1000 starts with a step S1002, in which the UE establishes an RRC connection with the gNB1. After the RRC connection is established (i.e., the UE is in RRC_CONNECTED state), a next step S1004 is initiated, in which the gNB1 signals the set of secured PRACH resources to the UE by using one or more encrypted messages. Then, the signaling diagram 1000 goes on to a step S1006, in which the UE transitions from the RRC connected state to the RRC idle state (i.e., RRC_IDLE). While the UE is in the RRC_IDLE state, the gNB2 detects a jamming attack on a set of public PRACH resources in a next step S1008. Further, the signaling diagram 1000 proceeds to a step S1010, in which the gNB2 starts broadcasting one or more plaintext messages indicating the ID(s) (e.g, “PRACH-ConfigurationIndex”) of the secured PRACH resource(s) selected (i.e., activated) by the gNB2 for further use for the PRACH preamble transmission. In a next step S1012, the UE decides to establish the RRC connection with the gNB2 (e.g., the UE has data to be transmitted via the gNB2) and receives the plaintext messages broadcasted by the gNB2. After that, the signaling diagram 1000 goes on to a step S1014, in which the UE finds, among the set of secured PRACH resources configured by the gNB1, one or more secured PRACH resources whose IDs are indicated in the received plaintext messages and starts transmitting a PRACH preamble towards the gNB2 by using the selected secured PRACH resource(s).

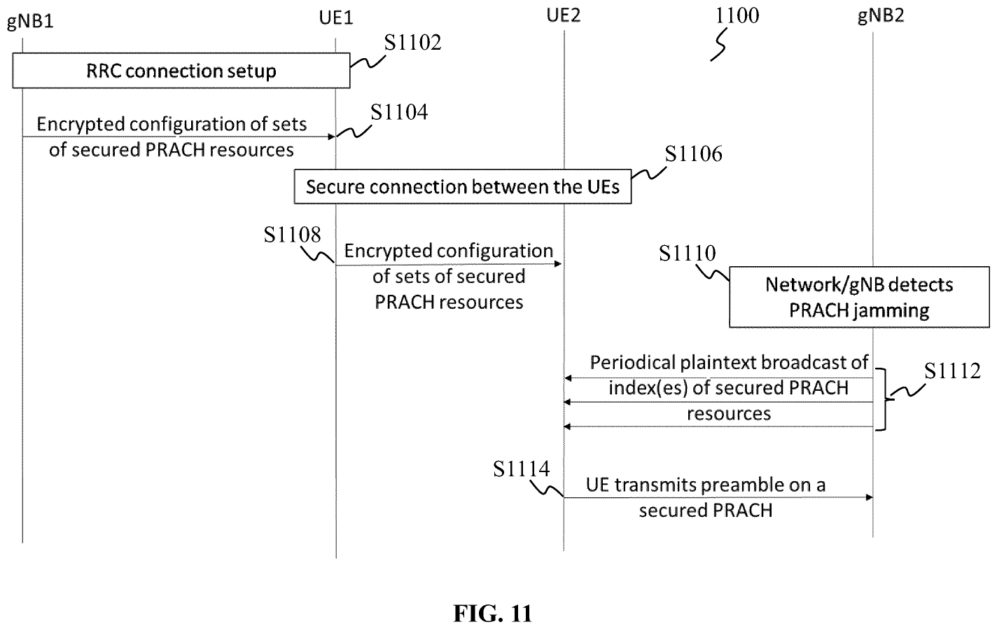

FIG. 11 shows a signaling diagram 1100 between two gNBs and two UE for configuring, activation and use of secured PRACH resources in accordance with a third example embodiment. In the signaling diagram 1100, it is assumed that each of gNB1 and gNB2 is implemented as the network node 100, and each of UE1 and UE2 is implemented as the UE 400. The signaling diagram 1100 may be used in scenarios when one trusted UE may obtain a set of secured PRACH resources from another trusted UE. It should be noted that the gNB1 and the gNB2 may be the same gNB serving both the UE1 and the UE2. The signaling diagram 1100 starts with a step S1102, in which the UE1 establishes an RRC connection with the gNB1. After the RRC connection is established (i.e., the UE1 is in RRC_CONNECTED state), a next step S1104 is initiated, in which the gNB1 signals the set of secured PRACH resources to the UE1 by using one or more encrypted messages. Then, the signaling diagram 1100 goes on to a step S1106, in which a secured connection is established between the UE1 and the UE2. By using the secured connection, the UE1 provides the set of secured PRACH resources to the UE2 by using one or more encrypted messages in a next step S1108. Next, the signaling diagram 1100 proceeds to a step S1110, in which the gNB2 detects a jamming attack on a set of public PRACH resources used by the UE2. In response to the jamming attack, in a next step S1112, the gNB2 starts broadcasting one or more plaintext messages indicating the ID(s) (e.g., “PRACH-ConfigurationIndex”) of the secured PRACH resource(s) selected (i.e., activated) by the gNB2 for further use for the PRACH preamble transmission. After that, the signaling diagram 1100 goes on to a step S1114, in which the UE2 finds, among the set of secured PRACH resources provided by the UE1, one or more secured PRACH resources whose IDs are indicated in the received plaintext messages and starts transmitting a PRACH preamble to the gNB2 by using the selected secured PRACH resource(s).

It should be noted that each step or operation of the methods 200, 500, 600, and 800 and the interaction diagrams 900-1100, or any combinations of the steps or operations, can be implemented by various means, such as hardware, firmware, and/or software. As an example, one or more of the steps or operations described above can be embodied by processor executable instructions, data structures, program modules, and other suitable data representations. Furthermore, the processor-executable instructions which embody the steps or operations described above can be stored on a corresponding data carrier and executed by the processor 102 or 402, respectively. This data carrier can be implemented as any computer-readable storage medium configured to be readable by said at least one processor to execute the processor executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the example embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. A network node in a wireless communication network, comprising:
at least one processor; and
at least one memory including a computer program code;
wherein the at least one memory and the computer program code are configured to, with the at least one processor, cause the network node to:
signal at least one public Physical Random Access Channel (PRACH) resource to at least one target User Equipment (UE);
signal at least one secured PRACH resource to each of the at least one target UE, each of the at least one secured PRACH resource having an identifier (ID);
signal the ID of an activated secured PRACH resource of the at least one secured PRACH resource to each of the at least one target UE, the activated secured PRACH resource being applicable instead of the at least one public PRACH resource; and
monitor a PRACH preamble from each of the at least one target UE based on the at least one of the public PRACH resource or the activated secured PRACH resource.

2. The network node of claim 1, wherein the at least one memory and the computer program code are further configured to, with the at least one processor, cause the network node to signal, together with the ID of the activated secured PRACH resource, an indication that each of the at least one target UE is allowed to:
initiate a Random Access (RA) procedure based on the activated secured PRACH resource.

3. The network node of claim 1, wherein the at least one memory and the computer program code are further configured to, with the at least one processor, cause the network node to signal, together with the ID of the activated secured PRACH resource, an indication that each of the at least one target UE is allowed to:
initiate the RA procedure based on the at least one public PRACH resource, and switch from the at least one public PRACH resource to the activated secured PRACH resource if the RA procedure based on the at least one public PRACH resource is unsuccessful.

4. The network node of any one of claims 1 to 3, wherein the at least one memory and the computer program code are further configured to, with the at least one processor, cause the network node to signal the at least one secured PRACH resource in an encrypted message, the encrypted message being encrypted using an encryption key that is pre-known to each of the at least one target UE.

5. The network node of any one of claims 1 to 4, wherein the at least one memory and the computer program code are configured to, with the at least one processor, cause the network node to signal the activated secured PRACH resource in response to a jamming attack on the at least one public PRACH resource.

6. The network node of any one of claims 1 to 5, wherein the at least one secured PRACH resource is valid within a geographical area comprising one or more cells.

7. The network node of any one of claims 1 to 6, wherein the ID of the activated secured PRACH resource comprises at least one of:
a format of the PRACH preamble;
a system frame and subframe at which the PRACH preamble is to be transmitted;
a time-domain location for the PRACH preamble;
a frequency-domain location for the PRACH preamble; and
a logical root sequence index.

8. The network node of any one of claims 1 to 7, wherein the at least one memory and the computer program code are further configured to, with the at least one processor, cause the network node to signal, together with the ID of the activated secured PRACH resource, a time duration within which the activated secured PRACH resource is valid.

9. A User Equipment (UE) in a wireless communication network, comprising:
at least one processor; and
at least one memory including a computer program code;
wherein the at least one memory and the computer program code are configured to, with the at least one processor, cause the UE to:
receive, from a network node, at least one public Physical Random Access Channel (PRACH) resource;
receive, from the network node, another network node or another UE, at least one secured PRACH resource each having an identifier (ID);
receive, from the network node, said another network node or said another UE, the ID of an activated secured PRACH resource of the at least one secured PRACH resource, the activated secured PRACH resource being applicable instead of the at least one public PRACH resource; and
transmit a PRACH preamble to the network node or said another network node based on the at least one public PRACH resource or the activated secured PRACH resource.

10. The UE of claim 9, wherein the at least one memory and the computer program code are further configured to, with the at least one processor, cause the UE to receive, together with the ID of the activated secured PRACH resource, an indication that the UE is allowed to:
initiate a Random Access (RA) procedure based on the activated secured PRACH resource.

11. The UE of claim 9, wherein the at least one memory and the computer program code are further configured to, with the at least one processor, cause the UE to receive, together with the ID of the activated secured PRACH resource, an indication that the UE is allowed to:
initiate the RA procedure based on the at least one public PRACH resource, and switch from the at least one public PRACH resource to the activated secured PRACH resource if the RA procedure based on the at least one public PRACH resource is unsuccessful.

12. The UE of any one of claims 9 to 11, wherein the at least one memory and the computer program code are further configured to, with the at least one processor, cause the UE to receive the at least one secured PRACH resource in an encrypted message, the encrypted message being encrypted using an encryption key pre-known to the UE.

13. The UE of any one of claims 9 to 12, wherein the at least one secured PRACH resource is valid within a geographical area comprising one or more cells.

14. The UE of any one of claims 9 to 13, wherein the ID of the activated secured PRACH resource comprises at least one of:
a format of the PRACH preamble;
a system frame and subframe at which the PRACH preamble is to be transmitted;
a time-domain location for the PRACH preamble;
a frequency-domain location for the PRACH preamble; and
a logical root sequence index.

15. The UE of any one of claims 9 to 14, wherein the at least one memory and the computer program code are further configured to, with the at least one processor, cause the UE to receive, together with the ID of the activated secured PRACH resource, a time duration within which the activated secured PRACH resource is valid.

16. A method for operating a network node in a wireless communication network, comprising:
signaling at least one Physical Random Access Channel (PRACH) resource to at least one target User Equipment (UE);
signaling at least one secured PRACH resource to each of the at least one target UE, each of the at least one secured PRACH resource having an identifier (ID);
signaling the ID of an activated secured PRACH resource of the at least one secured PRACH resource to each of the at least one target UE, the activated secured PRACH resource being applicable instead of the at least one public PRACH resource; and
monitoring a PRACH preamble from each of the at least one target UE based on the at least one public PRACH resource or the activated secured PRACH resource.

17. The method of claim 16, wherein the network node signals, together with the ID of the activated secured PRACH resource, an indication that each of the at least one target UE is allowed to:
initiate a Random Access (RA) procedure based on the activated secured PRACH resource.

18. The method of claim 16, wherein the network node signals, together with the ID of the activated secured PRACH resource, an indication that each of the at least one target UE is allowed to:
initiate the RA procedure based on the at least one public PRACH resource, and switch from the at least one public PRACH resource to the activated secured PRACH resource if the RA procedure based on the at least one public PRACH resource is unsuccessful.

19. The method of any one of claims 16 to 18, wherein the network node signals the at least one secured PRACH resource in an encrypted message, the encrypted message being encrypted using an encryption key that is pre-known to each of the at least one target UE.

20. The method of any one of claims 16 to 19, wherein the network node signals the activated secured PRACH resource in response to a jamming attack on the at least one public PRACH resource.

21. The method of any one of claims 16 to 20, wherein the at least one secured PRACH resource is valid within a geographical area comprising one or more cells.

22. The method of any one of claims 16 to 21, wherein the ID of the activated secured PRACH resource comprises at least one of:
a format of the PRACH preamble;
a system frame and subframe at which the PRACH preamble is to be transmitted;
a time-domain location for the PRACH preamble;
a frequency-domain location for the PRACH preamble; and
a logical root sequence index.

23. The method of any one of claims 16 to 22, wherein the network node signals, together with the ID of the activated secured PRACH resource, a time duration within which the activated secured PRACH resource is valid.

24. A method for operating a User Equipment (UE) in a wireless communication network, comprising:
receiving, from a network node, at least one public Physical Random Access Channel (PRACH) resource;
receiving, from the network node, another network node or another UE, at least one secured PRACH resource each having an identifier (ID);
receiving, from the network node, said another network node or said another UE, the ID of an activated secured PRACH resource of the at least one secured PRACH resource, the activated secured PRACH resource being applicable instead of the at least one public PRACH resource; and
transmitting a PRACH preamble to the network node or said another network node based on the at least one public PRACH resource or the activated secured PRACH resource.

25. The method of claim 24, wherein the UE receives, together with the ID of the activated secured PRACH resource, an indication that the UE is allowed to:
initiate a Random Access (RA) procedure based on the activated secured PRACH resource.

26. The method of claim 24, wherein the UE receives, together with the ID of the activated secured PRACH resource, an indication that the UE is allowed to:
initiate the RA procedure based on the at least one public PRACH resource, and switch from the at least one public PRACH resource to the activated secured PRACH resource if the RA procedure based on the at least one public PRACH resource is unsuccessful

27. The method of any one of claims 24 to 26, wherein the UE receives the at least one secured PRACH resource in an encrypted message, the encrypted message being encrypted using an encryption key pre-known to the UE.

28. The method of any one of claims 24 to 27, wherein the at least one secured PRACH resource is valid within a geographical area comprising one or more cells.

29. The method of any one of claims 24 to 28, wherein the ID of the activated secured PRACH resource comprises at least one of:
a format of the PRACH preamble;
a system frame and subframe at which the PRACH preamble is to be transmitted;
a time-domain location for the PRACH preamble;
a frequency-domain location for the PRACH preamble; and
a logical root sequence index.

30. The method of any one of claims 24 to 29, wherein the UE receives, together with the ID of the activated secured PRACH resource, a time duration within which the activated secured PRACH resource is valid.
